(19) United States
(12) Patent Application Publication
(10) Pub. No.: US 2010/0316552 A1
(43) Pub. Date: Dec. 16, 2010

(54) PROCESS FOR PREPARING HYDROGEN CYANIDE BY CATALYTIC DEHYDRATION OF GASEOUS FORMAMIDE

(75) Inventors: Ralf Boehling, Lorsch (DE); Andreas Deckers, Flomborn (DE); Thomas Schneider, Frankenthal (DE); Guenther Achhammer, Mannheim (DE); Hermann Luyken, Ludwigshafen (DE); Peter Pfab, Neustadt (DE); Klaus Schubert, Karlsruhe (DE); Manfred Kraut, Linkenheim-Hochstetten (DE)

Correspondence Address: OBLON, SPIVAK, MCCLELLAND MAIER & NEUSTADT, L.L.P., 1940 DUKE STREET, ALEXANDRIA, VA, 22314, US

(73) Assignees: BASF SE, Ludwigshafen (DE); KARLSRUHER INSTITUT F. TECHNOLOGIE KIT, Karlsruhe (DE)

(21) Appl. No.: 12/742,773

(22) PCT Filed: Nov. 10, 2008
(86) PCT No.: PCT/EP08/65185

§ 371 Date: Aug. 27, 2010

(30) Foreign Application Priority Data
Nov. 13, 2007 (EP) 07120540.5

(51) Int. Cl. C01C 3/02

(52) U.S. Cl. 423/373

(57) ABSTRACT

A process for preparing hydrogen cyanide, comprising the provision of gaseous formamide by evaporating liquid formamide in an evaporator (step i)) and the catalytic dehydration of the gaseous formamide (step ii)), and also an apparatus for performing the process according to the invention, comprising at least one microevaporator and a tubular reactor, and the use of a microevaporator for evaporating formamide in a process for preparing hydrogen cyanide from formamide.

The present invention relates to a process for preparing hydrogen cyanide, comprising the provision of gaseous formamide by evaporating liquid formamide in an evaporator (step i)) and the catalytic dehydration of the gaseous formamide (step ii)), and also to an apparatus for performing the process according to the invention, comprising at least one microevaporator and a tubular reactor, and to the use of a microevaporator for evaporating formamide in a process for preparing hydrogen cyanide from formamide.

Hydrogen cyanide is an important commodity chemical which serves as a starting material, for example, in numerous organic syntheses such as the preparation of adiponitrile, methacrylic esters, methionine and complexing agents (NTA, EDTA). Furthermore, hydrogen cyanide is required for the preparation of alkali metal cyanides which are used in mining and in the metallurgy industry.

The majority of hydrogen cyanide is produced by converting methane (natural gas) and ammonia. In the so-called Andrussow process, atmospheric oxygen is added simultaneously. In this way, the preparation of hydrogen cyanide proceeds autothermally. In contrast, the so-called BMA process of Degussa AG works without oxygen. The endothermic catalytic reaction of methane with ammonia is therefore operated in the BMA process externally with a heating medium (methane or H₂). A disadvantage of these processes is the high unavoidable occurrence of ammonium sulfate, since the conversion of methane proceeds economically only with an NH₃ excess. The unconverted ammonia is washed out of the untreated process gas with sulfuric acid. Furthermore, the high process temperature required in both aforementioned processes is disadvantageous.

A further important process for preparing HCN is the so-called SOHIO process. The ammoxidation of propene/propane to acrylonitrile forms approx. 10% (based on propene/propane) hydrogen cyanide as a by-product.

A further important process for industrially preparing hydrogen cyanide is the thermal dehydration of formamide under reduced pressure, which proceeds according to the following equation (I):

HCONH₂→HCN+H₂O (I)

This reaction is accompanied by the decomposition of formamide according to the following equation (II) to form ammonia and carbon monoxide:

HCONH₂→NH₃+CO (II)

Ammonia is scrubbed out of the untreated gas with sulfuric acid. Owing to the high selectivity, however, only a very small amount of ammonium sulfate is obtained.

The ammonia formed catalyzes the polymerization of the desired hydrogen cyanide and thus leads to an impairment of the quality of the hydrogen cyanide and to a reduction in the yield of the desired hydrogen cyanide.

The polymerization of hydrogen cyanide and the associated soot formation can be suppressed by the addition of small amounts of oxygen in the form of air, as disclosed in EP-A 0 209 039. EP-A 0 209 039 discloses a process for thermolytically cleaving formamide over highly sintered alumina or alumina-silica shaped bodies or over high temperature corrosion resistant chromium-nickel-stainless steel shaped bodies.

The prior art discloses further processes for preparing hydrogen cyanide by catalytically dehydrating gaseous formamide.

For instance, WO 02/070 588 relates to a process for preparing hydrogen cyanide by catalytically dehydrating gaseous formamide in a reactor which has an inner reactor surface composed of a steel comprising iron and also chromium and nickel, said reactor preferably not comprising any additional internals and/or catalysts.

WO 2006/027176 discloses a process for preparing hydrogen cyanide by catalytically dehydrating gaseous formamide, in which a return stream comprising formamide is obtained from the dehydration product mixture and recycled into the dehydration, said formamide-comprising return stream comprising from 5 to 50% by weight of water.

U.S. Pat. No. 2,429,262 discloses a process for preparing hydrogen cyanide by thermally decomposing formamide, wherein the formamide is decomposed catalytically by adding a solution of a substance selected from the group consisting of phosphoric acid and compounds which form phosphoric acid on thermal decomposition to a stream of formamide vapor, the mixture is heated to from 300 to 700° C. and the resulting products are cooled rapidly. According to U.S. Pat. No. 2,429,262, the formamide is preferably evaporated very rapidly to form formamide vapor. For example, the formamide can be introduced in a thin stream or in small discrete amounts into a fast evaporator heated to a temperature above the boiling point of formamide, preferably from 230 to 300° C. or higher.

U.S. Pat. No. 2,529,546 discloses a process for preparing hydrogen cyanide by thermally decomposing formamide, wherein the formamide is decomposed thermally in the vapor phase in the presence of a catalyst comprising a metal tungstate. U.S. Pat. No. 2,529,546—like U.S. Pat. No. 2,429,262—proposes evaporating formamide by using a fast evaporator with which the liquid formamide can be heated very rapidly.

According to the examples in U.S. Pat. No. 2,429,262 and U.S. Pat. No. 2,529,546, the evaporation of formamide is carried out at standard pressure at 250° C. However, it is evident from the examples in U.S. Pat. No. 2,529,546 that the selectivity in the process for preparing hydrogen cyanide disclosed in U.S. Pat. No. 2,529,546 is low.

DE-A 10 2005 051637 discloses a specific reactor system comprising a microstructured reactor having a reaction zone for performing a chemical reaction, said reaction zone being heated by means of a heat source. The heat source comprises contactless heating. The reactor system is suitable for catalytic gas phase applications, mention being made of HCN synthesis by the Andrussow process (oxidation of a mixture of ammonia and methane at approx. 1200° C. over a Pt catalyst (generally a Pt mesh)), by the Degussa-BMA process (catalytic conversion of ammonia and methane to hydrogen cyanide and hydrogen) and by the Shavinigan process (conversion of propane and ammonia in the absence of a catalyst at temperatures of generally >1500° C., in which the heat of reaction is supplied with the aid of a directly heated fluidized bed composed of carbon particles). From a process technology point of view, these typical high temperature gas phase reactions differ significantly from the process for preparing hydrogen cyanide by means of formamide cleavage, which comprises two stages, specifically the evaporation of formamide which is liquid at room temperature (boiling point: 210° C.) and the subsequent catalytic cleavage to hydrogen cyanide and water (catalytic dehydration). In addition to a reactor in which the formamide vapor is cleaved, it is thus necessary in this process to provide an evaporator in which the liquid formamide is first evaporated. Since the starting materials in the other aforementioned processes are gaseous at room temperature, these processes do not comprise any step corresponding to the evaporation of formamide.

With respect to the prior art cited above, it is an object of the present invention to provide a process for preparing hydrogen cyanide by catalytically dehydrating gaseous formamide, which has a high selectivity for the desired hydrogen cyanide and can be operated at maximum pressures (close to standard pressure or higher).

This object is achieved by a process for preparing hydrogen cyanide, comprising
i) providing gaseous formamide by evaporating liquid formamide in an evaporator; and
ii) catalytically dehydrating the gaseous formamide.

In the process according to the invention, the residence time of the formamide in the evaporator in step i) is <20 s, preferably <10 s, based on the liquid formamide.

It has been found that, surprisingly, owing to the very short residence times in the evaporator, the formamide can be evaporated in step i) virtually completely, preferably completely, without by-product formation. Typically, with the aid of the process according to the invention, formamide is evaporated with yield losses of <2% (based on the total amount of formamide used), preferably <0.5%.

Preference is given to performing the evaporation in step i) of the process according to the invention at a pressure of from 400 mbar to 4 bar, more preferably from 600 mbar to 2 bar, most preferably from 800 mbar to 1.4 bar. The temperatures in step i) of the process according to the invention are generally from 185 to 265° C., preferably from 210 to 260° C., more preferably from 215 to 240° C.

Hereinabove and hereinbelow, the pressure specified is understood in each case to mean the absolute pressure.

A further significant factor for the preparation of hydrogen cyanide by dehydrating gaseous formamide by the process according to the invention is not the surface loading, i.e. likewise not the heat transfer coefficient of the evaporator used in step i) to evaporate formamide. The surface loading of the evaporator is generally from 5 to 500 kg/(m²h). Here, efficient heat exchangers/evaporators corresponding to the state of the art achieve similar values. What is crucial is, surprisingly, the liquid loading based on the evaporator volume (volume-specific evaporator output). The volume-specific evaporator output of the evaporator used in step i) of the process according to the invention is preferably from 10 to 2000 MW/m³, more preferably from 50 to 1500 MW/m³, most preferably from 100 to 1000 MW/m³.

Preference is given to heating the evaporator used in step i) of the process according to the invention—in the case of a condensing medium or of a flowing liquid as a heat carrier—at a temperature which is at least 5° C., preferably from 5 to 150° C., more preferably from 10 to 100° C., most preferably from 20 to 50° C., above the boiling point of formamide (219° C.).

In the case of flowing gases as heat carriers, for example flue gases, the temperature is generally at least 5° C., preferably from 30 to 600° C., more preferably from 50 to 400° C., most preferably from 100 to 300° C., above the boiling point of the formamide (210° C.).

The heating medium used may be any heating medium (heat carrier) known to those skilled in the art, for example steam, heating gas or heating fluid. In addition, heating of the evaporator by electrical heat supply, for example by means of heating wires or heating cartridges, is possible. Suitable apparatus and measures for heating the surfaces of the evaporator are known to those skilled in the art.

Suitable evaporators in step i) of the process according to the invention include evaporators in which formamide can be evaporated with a residence time of <20 s, preferably <10 s, more preferably <2 s. In the process according to the invention, preference is given to using microstructured apparatus as evaporators in step i). The use of microstructured apparatus as evaporators—referred to hereinafter as microevaporators—is known to those skilled in the art and is described, for example, in DE-A 101 32 370, WO 2005/016512 and WO 2006/108796.

DE 101 32 370 describes a microevaporator for fuel cells which is small and provides a homogeneously evaporated medium. The medium which is evaporated according to DE-A 101 32 370 is methanol.

WO 2005/016512 describes a microevaporator which is used in a process for removing at least one volatile compound from a reactive or unreactive substance mixture. The microevaporator has channels for guiding the substance mixture which have a hydraulic diameter of from 5 to 1000 μm and a specific evaporator area of at least 10³ m²/m³.

WO 2006/108 796 describes a microevaporator comprising a casing consisting of thermally conductive material, in which a liquid feed chamber and a vapor collecting chamber are provided, between which microchannels with cross-sectional dimensions in the submillimeter range are arranged alongside one another in one plane, and comprising means of heating the liquid to be evaporated, the microevaporator channels being arranged in a trapezoidal region which has an entry region of smaller cross section opening into the liquid feed chamber and an exit region of greater cross section opening into the vapor collecting chamber. According to WO 2006/108796, the microevaporator is used in order to evaporate liquid media, for example water, alcohols or alcohol-water mixtures, liquid gases or liquid alkanes for further processing. the microevaporators are used, for example, in the fuel cell technology sector.

Suitable microevaporators are thus known to those skilled in the art. The use of microevaporators to evaporate formamide in a process for preparing hydrogen cyanide by dehydrating gaseous formamide is, however, not disclosed in the prior art.

A microevaporator used with preference in step i) of the process according to the invention comprises several parallel, microstructured layers of evaporation and heating channels arranged one on top of another in alternating succession, said layers preferably being configured such that each layer has a multitude of channels arranged parallel to one another which form a continuous flow path from one side of the layer to the opposite side of the layer.

In the context of the present invention, a layer is understood to mean a substantially two-dimensional, flat structural unit, i.e. a structural unit whose thickness in relation to its area is negligibly low. The layer is preferably an essentially flat panel.

The layers, especially panels, are—as mentioned above—microstructured by virtue of them having channels which are flowed through by formamide (so-called evaporator channels) or heat carrier (heating medium) (so-called heating channels). If the evaporator surfaces are heated by means of electrical heat supply, for example by means of heating wires or heating cartridges, the heating channels can be dispensed with. The term “microstructured” is understood to mean that the mean, hydraulic diameter of the channels is not more than 1 mm.

The present invention therefore further provides a process according to the invention in which, in step i) of the process according to the invention, a microevaporator which has channels to guide the formamide which have a hydraulic diameter of from 5 to 4000 μm, preferably from 10 to 1000 μm, more preferably from 100 to 300 μm, is used.

In a preferred embodiment of the microevaporator used in step i) of the process according to the invention, alternating with the layers (A) flowed through by formamide are arranged layers (B) to which a heat carrier is supplied on one side and is drawn off on the other side. In this case, it is possible that the alternating arrangement of layers A, B is configured such that each layer A is followed by a layer B, or such that two or more successive layers A are each followed by a layer B, or such that two or more successive layers B are each followed by a layer A.

The microevaporator used with preference is, according to the circumstances, generally formed from more than 30 layers, preferably more than 100 layers, more preferably more than 200 layers.

The channels of layers A and B can be arranged so as to give rise to crosscurrent, countercurrent or cocurrent flow. In addition, any desired mixed forms are conceivable.

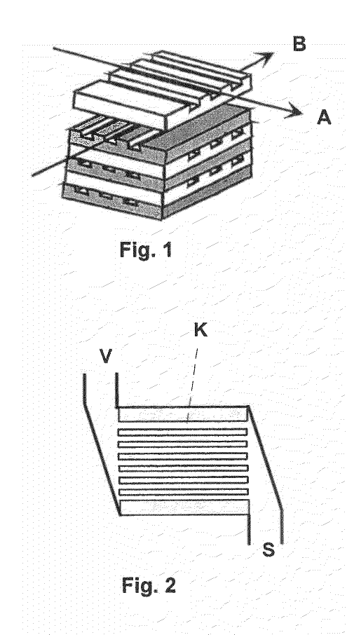

FIG. 1 shows, by way of example, a schematic three-dimensional section of a microevaporator, the layers A and B being arranged alternately in FIG. 1, each layer A being followed by a layer B, and the arrangement of layers A and B being such as to give rise to crosscurrent flow.

In FIG. 1:

A means layers A through which formamide flows
B means layers B through which heat carrier (heating medium) flows.

The arrows in each case indicate the flow direction of the formamide or of the heating medium.

The microevaporator used with preference in step i) of the process according to the invention comprises at least one distributor device and at least one collector device for distributing and collecting the formamide and the heat carrier. In one embodiment, the distributor and collector device is in each case configured as a chamber arranged outside or within a stack of layers A, B. In this case, the walls of the chambers may be straight or, for example, be curved in a semicircle. What is essential is that the geometric shape of the chamber is suitable for configuring flow and pressure drop so as to achieve homogeneous flow through the channels of the microevaporator. In a particularly preferred embodiment of a distributor, the liquid formamide is sprayed homogeneously from above onto the orifices of the evaporator channels, for example with nozzles known to those skilled in the art, or by flow toward the channels from below. In this case, the channels are heated in the lower region, generally at temperatures of <150° C., at which no decomposition takes place and the formamide is present in liquid form, and heated in the downstream part—the actual evaporator part.

In one embodiment of the present invention, the distributor and collector devices are each arranged within a stack of layers A, B, preferably by virtue of the channels of each layer A arranged parallel to one another, in the region of the two ends of the layers A, each having a cross-channel which connects the channels arranged parallel to one another and all cross-channels within the stack of layers A, B being connected by a collecting channel arranged essentially at right angles to the plane of the layers A, B. In this embodiment too, homogenous flow through the channels is essential.

In a preferred embodiment of the present invention, both for the layers A and for the layers B through whose channels a heat carrier flows, in each case a distributor and collector device are provided so as to correspond to the distributor and collector device for the layers A which have been described above.

FIG. 2 shows, by way of example, a schematic plan view of a layer, which may be a layer A or B. Within the layer, a distributor device V and a collector device S are shown schematically.

In FIG. 2,

V means distributor device
S means collector device
K means channels.

It may be advantageous to perform step i) of the process according to the invention in such a way that a temperature profile is passed through along the channels of each layer A by virtue of two or more heating or cooling zones per layer with in each case at least one distributor and collector device per heating or cooling zone of the layers B being provided for appropriate heating in the channels of the layers A.

The specific evaporator output of the microevaporator used with preference in step i) of the process according to the invention is, in a preferred embodiment of the present invention, from 5 to 200 kg/m²h, preferably from 10 to 200 kg/m²h, more preferably from 50 to 150 kg/m²h. The volume-specific evaporator output is generally from 100 to 2000 MW/m³.

The microevaporator used in accordance with the invention can be produced by the process known to those skilled in the art. Suitable processes are disclosed, for example, in V. Hessel, H. Löwe, A. Müller, G. Kolb, Chemical Micro Process Engineering-Processing and Plants, Wiley-VCH, Weinheim, 2005, p. 385 to 391 and W. Ehrfeld, V. Hessel, V. Haverkamp, Microreactors, Ullmann's Encyclopedia of Industrial Chemistry, Wiley-VCH, Weinheim 1999. Typically, the production comprises the generation of a microstructure in the individual layers by processing panels of materials suitable for the microevaporator, the stacking of the layers, the joining of the layers to assemble the microevaporator and the insertion of connections for the input of liquid formamide and the output of the gaseous formamide and if appropriate for the input and output of the heat carrier. DE-A 10 2005 051 637 describes various production processes for microstructured reactors which can be employed correspondingly to produce the microevaporator used in accordance with the invention.

In general, step i) of the process according to the invention is performed by feeding liquid formamide to the evaporator, preferably to the microevaporator. This is evaporated in step i) of the process according to the invention to gaseous formamide, which is then used in the catalytic dehydration in step ii) of the process according to the invention.

Preference is given to evaporating the formamide in step i) of the process according to the invention completely (without residue). Particular preference is given to evaporating the formamide in step i) completely and to superheating the resulting formamide vapor to temperatures of generally 230° C. or more. The superheated formamide vapor can be used directly in step ii).

Before the gaseous formamide obtained in step i) is fed into step ii) of the process according to the invention, oxygen can be added to the gaseous formamide, for example in the form of atmospheric oxygen or in the form of a gas mixture comprising oxygen, in which case the oxygen fraction can, if appropriate, be supplied in a preheated state.

In a preferred embodiment, step ii) of the process according to the invention is performed in the presence of oxygen, preferably atmospheric oxygen. The amounts of oxygen, preferably atmospheric oxygen, are generally from >0 to 10 mol %, based on the amount of formamide used, preferably from 0.1 to 10 mol %, more preferably from 0.5 to 3 mol %.

Subsequently, the gaseous formamide (formamide vapor) or the formamide-oxygen mixture, preferably the formamide-air mixture, can be brought in a heat exchanger to temperatures of 350° C. or more before it is supplied to step ii). However, it is likewise possible to use the aforementioned slightly superheated formamide vapor obtained in step i) directly, if appropriate after addition of oxygen, in step ii).

The catalytic dehydration in step ii) of the process according to the invention is effected generally at temperatures of from 350 to 650° C., preferably from 380 to 550° C., more preferably from 440 to 510° C. When, however, higher temperatures are selected, worsened selectivities and conversions are to be expected.

The pressure in step ii) of the process according to the invention is generally from 70 mbar to 3 bar, preferably from 400 mbar to 1.5 bar, preferably from 600 mbar to 1.4 bar.

The reactors used in step ii) of the process according to the invention may be all reactors known to those skilled in the art for the dehydration of formamide. In step ii) of the process according to the invention, preference is given to using tubular reactors, suitable tubular reactors being known to those skilled in the art. More preferably, the tubular reactors are multitube reactors. Suitable multitube reactors are likewise known to those skilled in the art.

Suitable materials of the reactors used in step ii) of the process according to the invention are likewise known to those skilled in the art. Preference is given to using an iron-containing surface as the inner surface of the reactor. In a particularly preferred embodiment, the inner reactor surface is formed from steel, which more preferably comprises iron and also chromium and nickel. The proportion of iron in the steel which preferably forms the inner reactor surface is generally >50% by weight, preferably >60% by weight, more preferably >70% by weight. The remainder is generally nickel and chromium, and it is possible if appropriate for small amounts of further metals such as molybdenum, manganese, silicon, aluminum, titanium, tungsten, cobalt with a proportion of generally from 0 to 5% by weight, preferably from 0 to 2% by weight to be present. Steel qualities suitable for the inner reactor surface are generally steel qualities corresponding to standards 1.4541, 1.4571, 1.4573, 1.4580, 1.4401, 1.4404, 1.4435, 2.4816, 1.3401, 1.4876 and 1.4828. Preference is given to using steel qualities corresponding to standards 1.4541, 1.4571, 1.4828, 1.3401, 1.4876 and 1.4762, particular preference to steel qualities corresponding to standards 1.4541, 1.4571, 1.4762 and 1.4828.

With the aid of such a tubular reactor, catalytic dehydration of gaseous formamide to hydrogen cyanide in step ii) of the process according to the invention is possible without having to use additional catalysts or the reactor having additional internals.

However, it is likewise possible that the catalytic dehydration in step ii) of the process according to the invention is performed in the presence of shaped bodies as catalysts, in which the shaped bodies are preferably highly sintered shaped bodies formed from alumina and if appropriate silica, preferably composed of from 50 to 100% by weight of alumina and from 0 to 50% by weight of silica, more preferably composed of from 85 to 95% by weight of alumina and from 5 to 15% by weight of silica, or of chromium-nickel stainless steel, as described, for example, in EP-A 0 209 039. In addition, suitable catalysts used in step ii) of the process according to the invention are packings made of steel or iron oxide on porous support materials, for example alumina. Suitable packings are described, for example, in DE-A 101 38 553.

When shaped bodies are used, the possible shaped bodies used may be either ordered or random moldings, for example Raschig rings, Pall rings, tablets, spheres and similar moldings. What is essential here is that the packings enable good heat transfer with a modest pressure drop. The size and geometry of the moldings used is guided generally by the internal diameter of the reactors to be filled with these shaped bodies, preferably tubular reactors.

Suitable packings made from steel or iron oxide are generally structured packings. The structured packings are preferably static mixers. The use of the static mixers allows a homogeneous pressure and excellent heat transfer to be achieved in the tubular reactor. The static mixers may have any geometries known to those skilled in the art. Preferred static mixers are constructed from metal sheets, which may be perforated sheets and/or molded sheets. It is of course likewise possible to use molded perforated sheets.

Suitable shaped bodies are described in EP-A 0 209 039, and suitable static mixers are described in DE-A 101 38 553.

It is likewise possible that, in step ii) of the process according to the invention, a reactor, preferably a tubular reactor, is used, which has shaped bodies and/or packings made of steel or iron oxide on a porous support, and whose reactor wall is additionally catalytically active. Suitable reactor wall materials which are catalytically active in step ii) of the process according to the invention are specified above and are described, for example, in WO 02/070588.

The optimal residence time of the formamide gas stream in step ii) of the process according to the invention, when a tubular reactor is used (which is preferred) is calculated from the length-specific formamide loading, which is preferably from 0.02 to 0.4 kg/(mh), preferably from 0.05 to 0.3, more preferably from 0.08 to 0.2, in the region of laminar flow. The optimal residence time of the formamide gas stream in step ii) of the process according to the invention, when a tubular reactor is used (which is preferred), is calculated from the area-specific formamide loading, which is generally from 0.1 to 100 kg/m², preferably from 0.2 to 50 kg/m², more preferably from 0.5 to 20 kg/m².

The process according to the invention for preparing hydrogen cyanide affords the desired hydrogen cyanide in high selectivities of generally >85%, preferably >90%, and conversions of generally >70%, preferably >80%, such that yields of generally >60%, preferably >75%, more preferably >88% are achieved.

In the case of the preferred use of microevaporators, as well as the advantages mentioned above, it is additionally possible to provide plants for preparing hydrogen cyanide which are significantly smaller than plants typically used to prepare hydrogen cyanide. Such plants are more mobile and therefore more versatile, and can, for example, be constructed where hydrogen cyanide is required, such that transport of hydrogen cyanide or salts of hydrogen cyanide (e.g. alkali metal and alkaline earth metal salts) over long distances can be avoided.

As mentioned above, the inventive apparatus for preparing hydrogen cyanide is small and therefore usable flexibly.

The present invention further provides for the use of a microevaporator for evaporating formamide in a process for preparing hydrogen cyanide from formamide.

Preferred microevaporators, preferred tubular reactors and a preferred process for preparing hydrogen cyanide from formamide have already been mentioned above.

The examples which follow provide additional illustration of the invention.

### EXAMPLES

### Evaporation

### Example 1

The experiments are performed in a batchwise laboratory distillation apparatus consisting of a three-neck flask, thermometer and water-cooled distillation apparatus. The flask is initially charged in each case with 50 g of formamide, brought to boiling temperature very rapidly at various pressures and distilled over. The heating is effected with an electrical heating mantle. The measure used for the formamide decomposition is the difference in mass between initially charged formamide and weight of distillate.

TABLE 1
Overview of the results for formamide evaporation in a flask.

| | Boiling | |
|---|---|---|
| | temperature measured | Formamide decomposition |
| Pressure [mbar] | [° C.] | [%] |
| 1010 (standard | 198 | 50.5 |
| pressure) | | |

### Example 2

The experiments are carried out with a microevaporator formed from 1700 rectangular channels. The rectangular channels have dimensions of 200×100 μm and length 14 mm. The rectangular channels are divided with half on the heating side and half on the evaporation side and are arranged in alternating layers in crosscurrent with respect to one another. Overall, the microevaporator is formed from 50 layers. The microevaporator is heated with 40 bar steam through the heating channels. The evaporator channels are charged with 100 g/h of formamide. This corresponds to a volume-specific evaporator output of 130 MW/m³. Over an experiment time of 6 h, no rise in pressure drop over the channels is observed. The formamide vapor is condensed with a customary laboratory condenser. The measure used for the formamide decomposition is the difference in mass between initially charged formamide and weight of condensate.

TABLE 2
Overview of the results for formamide
evaporation in a microevaporator

| | Temperature | |
|---|---|---|
| | of the formamide | Formamide |
| Pressure [mbar] | vapor on exit [° C.] | decomposition [%] |
| 1010 (standard pressure) | 225° C. | 0.5 |

### Decomposition

The experiment is carried out with tubular reactors of length 40 mm and internal diameter 12 mm. The experimental setup comprises a silver block into which the reaction tube was inserted with a close fit. The tubes consist of 1.4541 steel. The silver block is heated with heating rods. As a result of the good heat transfer in the silver bed, isothermal operation of the tube wall can be ensured. The reactor is charged with vaporous formamide and operated at 520° C.

### Example 3

The experiment is carried out in the apparatus as described above under “decomposition”. The reaction pressure is 600 mbar.

TABLE 3
Overview of formamide decomposition in
a tubular reactor at 600 mbar

| Formamide supply | Conversion | HCN selectivity |
|---|---|---|
| 100 g/h | 92% | 94 |

### Example 4

The experiment is carried out in the apparatus as described above under “decomposition”. The reaction pressure is 400 mbar.

TABLE 4
Overview of formamide decomposition in
a tubular reactor at 400 mbar

| Formamide supply | Conversion | HCN selectivity [%] |
|---|---|---|
| 100 g/h | 94% | 94% |

### Example 5

The experiment is carried out in the apparatus as described above under “decomposition”. The reaction pressure is 230 mbar.

TABLE 5
Overview of formamide decomposition in
a tubular reactor at 230 mbar

| Formamide supply | Conversion | HCN selectivity [%] |
|---|---|---|
| 100 g/h | 93% | 95% |

1-15. (canceled)

16. A process for preparing hydrogen cyanide, comprising
i) providing gaseous formamide by evaporating liquid formamide in an evaporator; and
ii) catalytically dehydrating the gaseous formamide,
wherein the residence time of the formamide in the evaporator in step i) is <20 s based on the liquid formamide, wherein the evaporator used in step i) is a microstructured apparatus.

17. The process according to claim 16, wherein the evaporation in step i) is effected at a pressure of from 400 mbar to 4 bar absolute.

18. The process according to claim 16, wherein the evaporation in step i) is effected at temperatures of from 185° C. to 265° C.

19. The process according to claim 16, wherein the volume-specific evaporator output of the evaporator used in step i) is from 10 to 2000 MW/m³.

20. The process according to claim 16, wherein the microevaporator has channels to guide the formamide which have a hydraulic diameter of from 5 to 4000 μm.

21. The process according to claim 16, wherein the microevaporator has a volume-specific evaporator output of from 100 to 2000 MW/m³.

22. The process according to claim 16, wherein the catalytic dehydration in step ii) is effected at temperatures of from 350 to 650° C.

23. The process according to claim 16, wherein the catalytic dehydration in step ii) is performed at a pressure of from 70 mbar to 3 bar absolute.

24. The process according to claim 23, wherein the dehydration in step ii) is performed at a pressure of from 400 mbar to 1.5 bar absolute.

25. The process according to claim 16, wherein the catalytic dehydration in step ii) is effected in a tubular reactor.

26. The process according to claim 16, wherein the catalytic dehydration in step ii) is effected in the presence of shaped bodies selected from highly sintered shaped bodies formed from alumina and, optionally, silica, and chromium-nickel-stainless steel shaped bodies, or in the presence of packings made of steel or iron oxide on porous support materials as catalysts, and/or the inner reactor surface of the tubular reactor is formed from steel and serves as a catalyst.

27. The process according to claim 16, wherein the catalytic dehydration in step ii) is performed in the presence of oxygen.

28. The process according to claim 25, wherein the catalytic dehydration in step ii) is effected at a length-specific formamide loading of from 0.02 to 0.4 kg/(mh) in the range of laminar flow.
